(19) United States
(12) Patent Application Publication
(10) Pub. No.: US 2009/0312062 A1
(43) Pub. Date: Dec. 17, 2009

(54) METHOD FOR INDICATING SOFT KEY CHANGE USING ANIMATION

(76) Inventors: Samuel Jacob HORODEZKY, San Diego, CA (US); Clifton SCOTT, San Diego, CA (US); Kam-Cheong Anthony TSOI, San Diego, CA (US)

Correspondence Address: QUALCOMM INCORPORATED, 5775 MOREHOUSE DR., SAN DIEGO, CA, 92121, US

(21) Appl. No.: 12/140,061

(22) Filed: Jun. 16, 2008

(51) Int. Cl. H04M 1/00; G06T 13/00

(52) U.S. Cl. 455/566; 345/473

(57) ABSTRACT

Systems and methods provide an attention grabbing display when the function mapped to a soft key and the associated soft key label has changed. Animation is used to draw a user's attention to the soft key label change, thereby alerting the user to the changed function mapped to the soft keys.

### FIELD OF THE INVENTION

The present invention relates generally to cellular telephone displays, and more particularly to displays to indicate that a soft key function has changed.

### BACKGROUND

Usage of wireless mobile communication devices (mobile devices), such as cellular telephones, is ever increasing due to their portability and connectivity. Mobile devices are also growing in sophistication, supporting many useful applications that can run simultaneously, and becoming multipurpose productivity tools. To provide flexibility in user input keys, many applications that run on the mobile devices use soft keys as part of the user interface. A soft key is a button, located alongside or beneath the device's display which is associated with a function that is defined by the application. To inform users of the function associated with each soft key, the display will typically include text appearing above, beside or otherwise close to the physical key. In contrast, hard keys are hard-coded keys, such as a number key pad or the Send/End key of a mobile phone, for which the associated function can be printed on the keys themselves.

A typical mobile phone has soft keys located at the left (LSK), right (RSK) and center (CSK) of the device just beneath the display. Depending on the modality of the application, various functions can be mapped onto each soft key, with the mapped function appearing on the display just above the key. A soft key can also bring up multiple functions listed on a pop-up expanded menu, with the menu appearing on the display above the key.

As a user executes different applications on the mobile device, the function mapped to each soft key may vary with each application. Heretofore, when the function mapped to a soft key changes, the soft key function presented on the display changes instantaneously. Such instantaneous display changes are often not readily apparent to the user, particularly when the main elements of the display remain unchanged. Users can easily lose track of the function mapped to each soft key when launching or switching applications. As a result, the user may inadvertently enter incorrect commands using a soft key not realizing that the soft key function has changed.

### SUMMARY

Various embodiment systems and methods are disclosed which utilize animation to provide an attention-grabbing indication that the function mapped to a soft key has changed on a mobile device. When an application changes the function mapped to a soft key, the change is denoted by an animation which draws the user's attention to the change. Various embodiments disclosed herein provide themeable animations for indicating a change in soft key function.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIG. 1 is a perspective view of a typical mobile device with soft keys.

FIGS. 2A-2D are display images showing an exemplary embodiment.

FIG. 3 is a process flow diagram of a method for implementing a soft key change animation according to an embodiment.

FIG. 4 is a process flow diagram of a method for implementing a soft key change animation according to a preferred embodiment.

FIG. 5 is a process flow diagram of a method for implementing a soft key change animation according to an alternative embodiment.

FIG. 6 is a system block diagram of a mobile device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the terms “mobile device”, “mobile handset”, “handset” and “handheld device” refer to any one or all of cellular telephones, personal digital assistants (PDAs), wireless electronic mail receivers (e.g., the Blackberry® and Treo® devices), multimedia Internet enabled cellular telephones (e.g., the iPhone®), and similar personal electronic devices. In a preferred embodiment, the mobile device is a cellular handset device (e.g., a cellphone). However, cellular telephone communication capability is not necessary as the various embodiments may be implemented on any computing device which utilizes soft keys. Thus, the various embodiment methods may be implemented on laptop as well as desktop computers. Consequently, the terms “mobile device”, “mobile handset”, “handset” and “handheld device” may also refer to a laptop or desktop computing device.

Technological developments have greatly expanded the variety of applications capable of executing on mobile device processors. The level of sophistication and power of the various applications capable of running on a mobile device is often hampered by the rudimentary user interface which is limited by the small size of such devices. In many implementations the limited number of hard keys available on a mobile device are insufficient to enable the user to fully utilize features available to various applications. Soft keys are one way to increase the flexibility of user interface capabilities of a mobile device with a limited number of keys.

A typical mobile phone has soft keys located at the left (LSK), right (RSK) and center (CSK) of the device just beneath the display. Depending on the modality of the application, various functions can be mapped onto each soft key, with the mapped function appearing on the display just above the key. A soft key can also bring up multiple functions listed on a pop-up expanded menu, with the menu appearing on the display above the key.

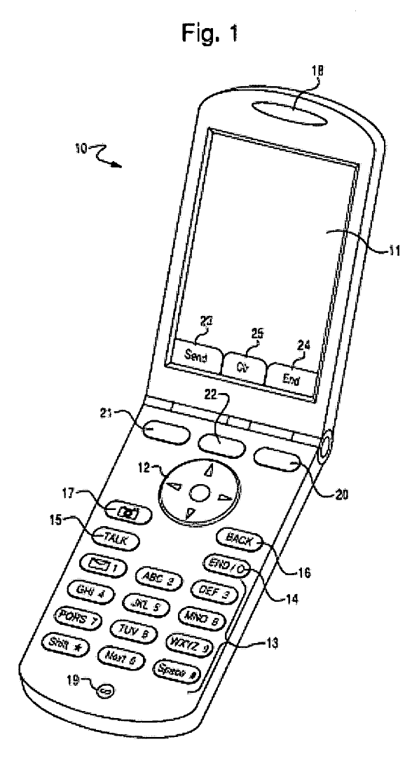

FIG. 1 illustrates a conventional mobile device which employs soft keys. As shown in FIG. 1, a mobile device 10 (in the illustrated example, a cellular telephone handset) includes a display 11 and a number of keys which make up its user interface input. The user interface input may include a numeric keypad 13 which includes digits 0-9 as well as a “*” and “#” key. The numeric keypad may also include alphabetic characters which may be accessed by a series of depressions of a single numeric key. In addition, the user interface input may include other hard keys (i.e., fixed function keys) such as a “SEND” key 15 which initiates a voice call session, an “End/Power” key 14 which terminates a voice call session and may also be used to turn power of the mobile device 10 on and off. The user interface input may also include other hard keys such as a camera key 17 which controls a built in digital camera. The user interface input may also include a multi-directional menu selection key 12 and/or a “Back” key 16 for use in navigating a menu system. Also depicted in FIG. 1 are a speaker 18 and microphone 19.

The mobile device 10 may also include soft keys, such as soft key buttons 20, 21, and 22 in FIG. 1. Soft keys are generic keys which typically are not hard labeled. Rather the function of the soft key is denoted on the display 11 in an area sometimes referred to as the soft key area. The specific function mapped to each soft key is denoted on soft labels 23, 24, and 25. While FIG. 1 shows three separate soft keys 20, 21, and 22, one of skill in the art would appreciate that a mobile device 10 may have any number of soft keys. As shown in FIG. 1, the soft key label 23 of soft key 21 is mapped to a “Send” function. The soft key label 24 of soft key 20 is mapped to an “End” function and the soft key label 25 of soft key 22 is mapped to an “Clr” function. These may be the default functions and labels set by either the OEM or user for use on the default standby screen on display 11. Alternatively, these functions and labels may be controlled by the application executed on the mobile device 10. For example, the particular soft key functions and labels may be set to provide the user interface for the SMS text messaging application. In such applications, depressing the soft key 21 associated with the “send” soft key label 23 sends the text SMS message that has been composed. Alternatively, depressing the soft key 22 associated with the “clr” soft key label 25 clears the message or address.

While the soft key labels 24, 23, 25 are typically found at the bottom of display 11, one of skill in the art would appreciate that soft key labels may be located on any portion of the display 11 so long as they are easily associated with the soft keys 20, 21, 22.

The function mapped to each soft key 20, 21, 22 and the respective soft key label 24, 23, 25 may change frequently. The function and label may change due to a new application launching on the mobile device 10. The function and label may also change within an application, such as when a user “drills down” into different levels of an application's menu system. It may also change due to a highlight of cursor change on the same screen.

In instances where users launch a new application that changes the entire user interface display 11, users may expect that some or all aspects of the new user interface display 11 may change as compared to the previous display. Changing of the entire display may also cause users to scan the new display, and thereby recognize that the soft key function assignments have changed. Consequently, when the entire user interface display 11 changes, users will anticipate that the soft key label 24, 23, 25 and the function mapped to the soft keys 20, 21, 22 will also change.

However, it may be the case that launching a new application does not change the entire user interface display 11. Also, some applications have operating modes which change the soft key functions. This is particularly the case when the same application is running, but subtle changes occur, such as changes to the soft key functions and labels. For example, as a user “drills down” in a system menu, the overall menu display may not change, but the soft key functions may change, and thus the soft key labels on the display 11 may change. Heretofore, the change of soft key labels on the display 11 has been quick, sometimes subtle. and sometimes unexpected. Thus, when only the soft key labels 23, 24, 25 change, users often fail to notice.

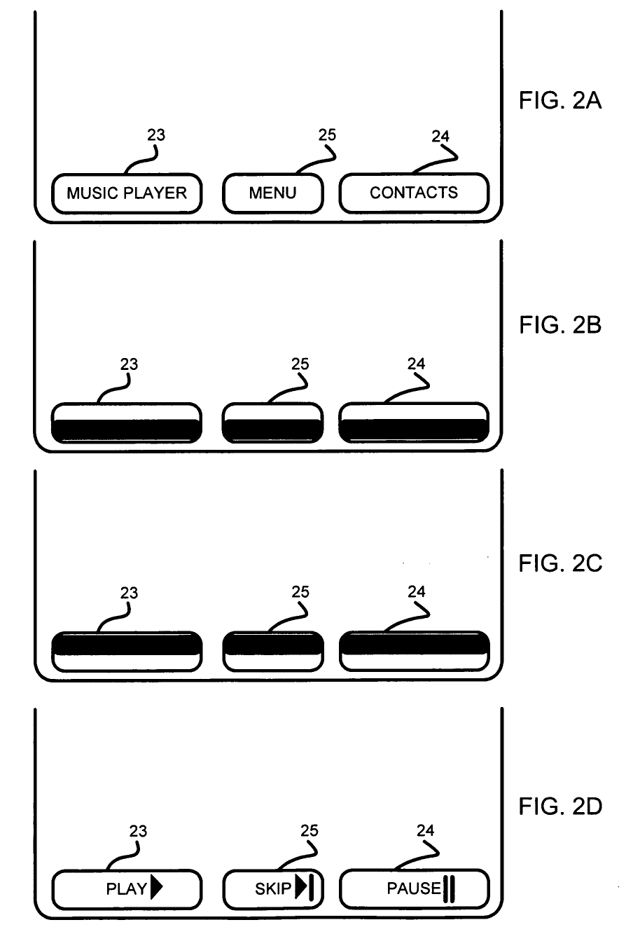

Embodiments disclosed herein utilize animation to draw users' eyes and attention to any change to soft key labels 24, 23, 25. By directing users' attention to changing soft key labels, users are made aware of the change to the function mapped to the soft keys 20, 21, 22 at the moment the changes are effected. Such animations may be part of the users' themes or selected by users from a variety of alternative animations. FIGS. 2A-2D illustrate a simple sequence of images that may be displayed successively to provide the user with the appearance of motion (animation). FIGS. 2A-2D show the bottom portion of a user display 11 including soft key labels 23, 25, 24 indicating the assigned function of soft keys 21, 22, 20, respectively (see FIG. 1). Before a change, the soft key labels 23, 25, 24 indicate functions of “MUSIC PLAYER,” “MENU,” and “CONTACTS,” respectively. When a change to soft key functions occurs, requiring a change to the soft key labels, an animation routine is launched which causes the soft key area of display 11 to exhibit motion to the soft key labels 23, 24, 25. For example, a user may depress soft-key 23 “MUSIC PLAYER” to launch the MP3 player application. FIGS. 2B and 2C show intermediate images which can be presented in quick succession between changing from the display shown in FIG. 2A to the display shown in FIG. 2D. FIG. 2D illustrates the soft key labels 23, 24, 25 after a change has been effectuated in which the soft key functions are associated with a media player, such as a MP3 player or video player. In FIG. 2D soft key label 23 indicates “Play,” soft key label 24 indicates “Pause,” and soft key label 25 indicates “Skip.” When the images of FIGS. 2B and 2C are shown successively between the images of 2A and 2D, the display 11 will appear to roll over from “MUSIC PLAYER,” “MENU,” “CONTACTS” to “PLAY,” “SKIP,” “PAUSE.” Thus, when the functions mapped to soft keys 20, 21, 22 and the associated soft key labels 24, 23, 25 are changed, a rollover animation occurs in which the old soft key labels 24, 23, 25 slowly roll upward and disappear, as the new soft key labels 24, 23, 25 roll up to take their place.

In the various embodiments, animation may be created by recalling from memory a series of images for display in sequence. For example, the intermediary images shown in FIGS. 2B and 2C may be stored in memory. More complex animations may be provided by storing a series of images, such as intermediary images, icons, or more complex images (e.g., race cars or elements of a user's theme).

Similar embodiments may be implemented on laptop and desktop computing devices where menus or toolbars may be configured to use animation to make the appearance and disappearance of menu items more obvious. For example, when users select a button on a floating palette a menu or toolbar may be removed from display. In such instances it would be useful to draw the user's attention to the change in menu functions and display. For sake of simplicity, the various embodiments may be described with reference to a mobile device and the soft key labels and functions. However, the embodiments may also be implemented on a laptop or desktop computer and such implementations are consistent with the spirit and scope of the present invention.

The function mapped to any of soft keys 20, 21, 22 and the associated soft key labels 24, 23, 25 may change independently. Alternative embodiments may utilize other forms of animation to draw the users' attention to the soft key change. For example, the rollover animation may display a horizontal rollover (i.e., rolling about a vertical centerline) as opposed to the vertical rollover shown in FIGS. 2A-2D. As another example, a gradient color change or other graphical elements with motion may be used to draw users' attention to the changing soft key labels.

Other embodiments may be implemented wherein the graphic animation shown on the user interface display relates to different kinds of moving images or a theme of the user's choosing. For example, race cars may be shown to pass over the soft key window whenever a soft key label change is effected. Other example animations include a runner running or a swimmer swimming in the soft key window whenever a soft key label change is effected. Any graphical image that can be incorporated into an animation sequence may be utilized. A number of different animation images or icons may be provided with a menu application provided to enable a user to select a particular animated image or icon to indicate soft key changeover. Also, animated images or icons may be selected for or based upon a theme applied to or selected for the mobile device. Also, animated images or icons may be determined by the application being initiated so that an animation associated with the application is observer. For example, if a game application is being loaded, the soft key change animation may be an actor or graphic featured in the game.

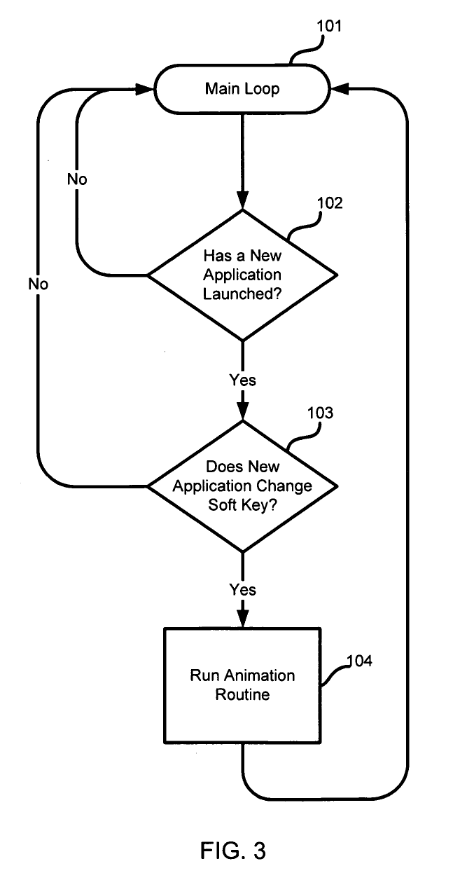

An animated soft key changeover indicator may be implemented in software instructions operating on the mobile device by employing a variety of software methods. FIG. 3 illustrates a process flow diagram of an example embodiment. This embodiment may be implemented as part of the mobile device 10 processor main loop routine 101. A main loop routine 101 may be used to control the various applications and functions of the mobile device 10. When the application running on the mobile device 10 has changed or is being change, a changed application flag may be set, such as by storing a “1” in a particular memory register). Periodically the main loop 101 checks the changed application flag to see if it has been set, test 102. If the changed application flag is not set (i.e., Test 102=“No”) then the main loop routine 101 continues until the next opportunity to check the changed application flag.

If the changed application flag is set (i.e., Test 102=“Yes”), indicating a new application is being executed on the mobile device 10 processor, the new application is checked to determine if a change to soft key labels is required, test 103. This may be indicated by a change soft key function/label flag that may be set (such as by storing a “1” in a particular memory register) when the new application is initiated. Alternatively, the main loop may check memory registers associated with the display 11 to determine if the soft key label portions of the display have been changed. If the change soft key function/label flag is not set (i.e., Test 103=“No”) then there is no need to change the soft key function or label and the main loop routine 101 continues processing until the next opportunity to check the changed application flag.

If the change soft key function/label flag is set (i.e., Test 103=“Yes”), indicating a new application is being executed on the mobile device 10 processor that requires changing the soft key labels, then the processor may execute a soft key label animation routine, step 104. The soft key label animation routine 104 may be configured to exhibit motion which draws the user's attention to the change in soft key labels on the user interface display 11. Once the animation routine has completed, the new soft key labels will be displayed and the processor returns to the main loop routine 101.

As would be appreciated by one of skill in the art, flags which indicate that a new application is initiating and/or that soft key labels are changing may be cleared as part of or immediately after the step of testing the flags, tests 102, 103. Clearing the flags ensures the animation are only activated once.

The soft key animation routine may use a variety of known methods for presenting moving graphics on the display of a mobile device. In a simple example, the animation program may simply sequence through a series of incrementing images stored in memory that are shown in a sufficiently rapid succession so as to appear as continuous movement, such as illustrated in FIGS. 2A-2D. The animation routine may be modified by the user to continue for a sufficient period of time to ensure users observe the soft key change over. For example, the animation routine may continually loop for a set period of time (which may be set by a user), ultimately ending with the new soft key labels presented in a static display. Additional image elements such as fireworks, starbursts, etc. may be implemented to further draw the user's attention to the change in soft key function and labels.

As mentioned above, in an embodiment the animated graphic signaling the soft key changeover may be part of a user's theme. For example, a user may chose to display his favorite NASCAR® driver's car as a wallpaper that is shown whenever the processor of the mobile device is in a standby state. In this example, once a soft key function and label changeover is activated, the NASCAR® driver's car may start to drive across the user interface display or the wheels may turn until the soft key labels have changed to their new display.

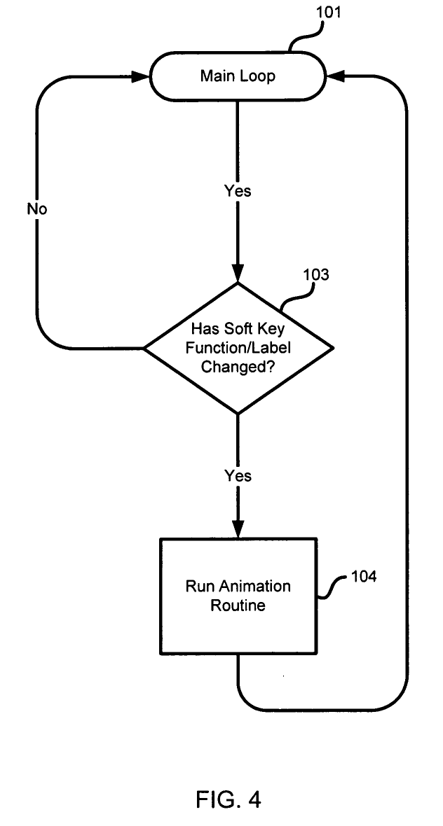

FIG. 4 illustrates a process flow of a preferred embodiment for drawing a user's attention to a change in soft key function and labels. This embodiment may be implemented as part of the mobile device or computer processor main loop routine 101. This preferred embodiment addresses situations in which the soft key function/label may change within an application (i.e., there is no change of applications). For example, when a call log application is running on the mobile device 10 recently called, missed and received phone numbers or contact names are shown in a list on the display 11. Using the multi-directional menu selection key 12 a user may scroll through the displayed list to select and highlight a particular contact name or phone number. Once highlighted, the user may instantaneously call the contact name or phone number by depressing the “SEND” key while the contact name or phone number is highlighted. In instances where a phone number is highlighted, because the phone number is not already saved in the contact list, a soft key may automatically change the soft key function and label to a “SAVE” function so that the user may quickly save the previously unknown phone number to the user's contact list. However, where a contact name is highlighted, because the contact name and number is already saved in the contact list, the soft key may not be mapped to any function. As the user scrolls between contact names and phone numbers, the soft key function/label will change back and forth between the nil function/label and the “SAVE” function/label. Because the soft key function and label changes within the application, a user may not be aware of the soft key function and label change. Accordingly, it is useful to draw the user's attention to the change in soft key function/label through the use of an animation routine.

Referring to FIG. 4, when an application running on the mobile device 10 changes the function/label associated with one or more soft keys, a changed function/label flag may be set (such as by the application storing a “1” in a particular memory register). Then during execution of the main loop 101, the changed function/label flag can be tested, test 103. If the changed function/label flag is not set (i.e., Test 103=“No”) then the main loop routine 101 continues until the next opportunity to check the changed application flag. If the changed application flag is set (i.e., Test 103=“Yes”), indicating that the function and label of one or more soft keys has changed, then the processor may execute a soft key label animation routine, step 104, as described above. As part of presenting the animation routine, step 104, the changed function/label flag may also be reset so the animation is not repeated unnecessarily.

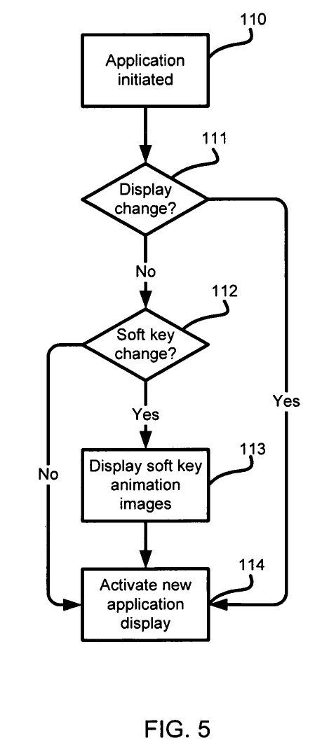

FIG. 5 illustrates a process flow of an alternative embodiment for drawing a user's attention to a change in soft key function and labels. This embodiment may be implemented by the processor controlling the user interface display 11. Whenever a new application is initiated, step 110, the processor checks to see if the new application requires a change to the entire user interface display 11, test 111. If the entire user interface display 11 has changed or will be changed by the new application, it is likely that the user will recognize that the function and label of the soft keys will have also changed. Therefore, an animation routine drawing the user's attention to a soft key label change is not needed. Accordingly, if the newly initiated application requires a change to the entire user interface display 11 (i.e., Test 111=“Yes”) then the new application display is simply activated, step 114, without any special animation routine.

If the newly initiated application does not require an entire user interface display 11 change (i.e., Test 111=“No”) then the processor may determine whether the function/label of any soft key has changed or will change, test 112. If the soft key function/label changes without changing the entire user interface display 11, the user may not notice the soft key function/label change without some attention grabbing animation. Accordingly, if the soft key function/label requires a change (i.e., Test 112=“Yes”), then the processor implements the soft key animation images, step 113. As described above with reference to FIGS. 2A-2D, the images and animations displayed in step 113 may employ any of a variety of techniques, such as a rollover type animation. After the animation images are displayed, step 113, the new application display is activated, step 114, which will include the new soft key function labels 23, 24, 25. However, if no change to a soft key function/label is occurring (i.e., Test 112=“No”), then the new application display is immediately activated, step 114. Since no change to the soft key function/label is needed, no animation images are displayed.

The embodiments described above may be implemented on any of a variety of mobile devices, such as, for example, cellular telephones, personal data assistants (PDA), mobile electronic mail receivers, mobile web access devices, and other processor equipped devices that may be developed in the future. In addition, the embodiments described above may be implemented on any of a variety of computing devices that implement soft keys, including but not limited to desktop and laptop computers. For example, most personal computers include a set of general function keys F1 through F12 that are assigned functions by applications. The function of the general function keys F1 through F12 may be denoted by labels shown on a display, which may change as the function assigned to each general function key changes.

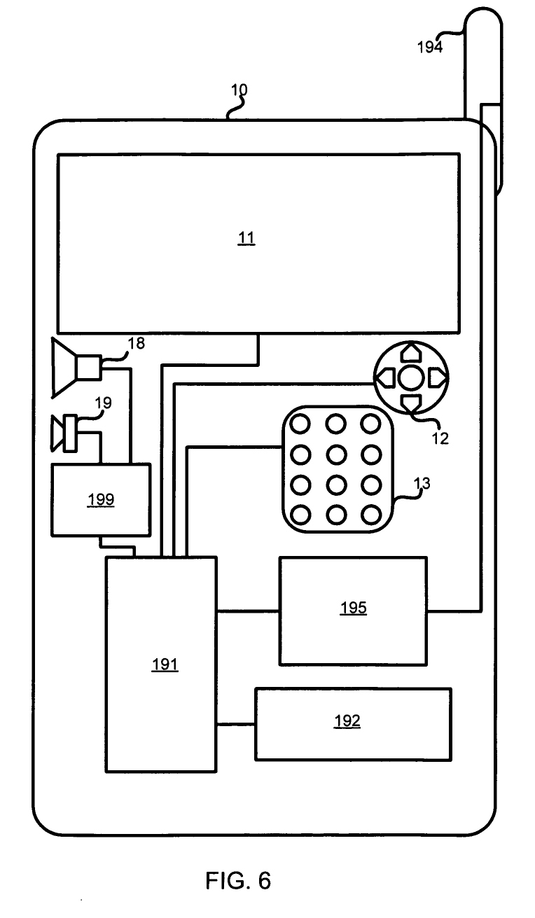

FIG. 6 depicts various components of a mobile device 10 capable of supporting the various embodiments disclosed herein. A typical mobile device 10 includes a processor 191 coupled to internal memory 192 and a user interface display 11. Additionally, the mobile device 10 may have an antenna 194 for sending and receiving electromagnetic radiation that is connected to a wireless data link and/or cellular telephone transceiver 195 coupled to the processor 191. In some implementations, the transceiver 195, and portions of the processor 191 and memory 192 used for cellular telephone communications is referred to as the air interface since it provides a data interface via a wireless data link. Further, the mobile device 10 includes a speaker 18 to produce audible audio signals to the user. The mobile device also includes a microphone 19 for receiving the audio speech of the user. Both microphone 19 and speaker 18 may be connected to the processor 191 via a vocoder 199 which transforms the electrical signals into sound waves and vice versa. In some implementations, the vocoder 199 may be included as part of the circuitry and programming of the processor 191.

The processor 191 may be any programmable microprocessor, microcomputer or multiple processor chip or chips that can be configured by software instructions (applications) to perform a variety of functions, including the functions of the various embodiments described above. In some mobile devices, multiple processors 191 may be provided, such as one processor dedicated to wireless communication functions and one processor dedicated to running other applications. Typically, software applications may be stored in the internal memory 192 before they are accessed and loaded into the processor 191. In some mobile devices, the processor 191 may include internal memory sufficient to store the application software instructions. For the purposes of this description, the term memory refers to all memory accessible by the processor 191, including internal memory 192 and memory within the processor 191 itself. The memory 192 may be volatile or nonvolatile memory, such as flash memory, or a mixture of both. Mobile handsets typically include a key pad 13, as well as other hard keys 14, 15, 16, 17 (see FIG. 1) and menu selection buttons or rocker switches 12 for receiving user inputs.

The various embodiments described above may be implemented on a typical mobile device 10 by a user executing a new application via keypad 13 and/or menu selection buttons 12 and an application dispatcher in memory 192 which comprises processor executable software instructions that will cause the processor 191 to execute the embodiment methods described herein to display an animated graphical image on user interface display 11.

The hardware used to implement the foregoing embodiments may be processing elements and memory elements configured to execute a set of instructions, wherein the set of instructions are for performing method steps corresponding to the above methods. Alternatively, some steps or methods may be performed by circuitry that is specific to a given function.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. The software module may reside in a processor readable storage medium and/or processor readable memory both of which may be any of RAM memory, flash memory, ROM memory, EPROM memory, EEPROM memory, registers, hard disk, a removable disk, a CD-ROM, or any other tangible form of data storage medium known in the art. Moreover, the processor readable memory may comprise more than one memory chip, memory internal to the processor chip, in separate memory chips, and combinations of different types of memory such as flash memory and RAM memory. References herein to the memory of a mobile handset are intended to encompass any one or all memory modules within the mobile handset without limitation to a particular configuration, type or packaging. An exemplary storage medium is coupled to a processor in either the mobile handset or the theme server such that the processor can read information from, and write information to, the storage medium. In the alternative, the storage medium may be integral to the processor. The processor and the storage medium may reside in an ASIC.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

We claim:

1. A method for indicating a change of function of a soft key, comprising:
determining whether a change to a soft key label is required; and
activating a soft key animation routine if a newly initiated application requires the change to the soft key label.

2. The method of claim 1, further comprising monitoring whether a new application has been initiated,
wherein the step of determining whether the change to a soft key label is required is performed only if the new application has been initiated.

3. The method of claim 1 wherein the step of activating the soft key animation routine comprises displaying a series of images stored in memory prior to displaying a static image including a changed soft key label.

4. The method of claim 3, further comprising displaying a new soft key label on a user interface display as a static image after completion of the soft key animation routine.

5. The method of claim 1, wherein the step of activating the soft key animation routine comprises presenting a series of intermediary images in short succession to create an appearance of a rollover of a soft key label.

6. A method for indicating a change of function of a soft key, comprising:
determining whether an entire user interface display requires a change upon initiation of a new application;
determining whether the initiation of the new application requires a change to a soft key label; and
activating a soft key animation routine only if the newly initiated application requires the change to the soft key label but not to the entire interface display.

7. A mobile device, comprising:
a user interface display;
a user interface keypad, the user interface keypad including at least one soft key;
a processor coupled to the user interface keypad and the user interface display; and
a memory coupled to the processor; said memory having stored therein processor executable software instructions configured to cause the processor to perform steps comprising:
displaying a soft key label associated with the at least one soft key;
determining whether a change to the soft key label is required; and
activating a soft key animation routine if the newly initiated application requires the change to the soft key label.

8. The mobile device of claim 7, wherein the processor executable software instructions stored in the memory are configured to cause the processor to further perform steps comprising monitoring whether a new application has been initiated,
wherein the step of determining whether the change to the soft key label is required is performed only if the new application has been initiated.

9. The mobile device of claim 7, wherein the processor executable software instructions stored in the memory are configured to cause the processor to further perform steps comprising displaying a series of images which exhibit soft key label motion on the user interface display prior to displaying a static image including a changed soft key label.

10. The mobile device of claim 9, wherein the processor executable software instructions stored in the memory are configured to cause the processor to further perform steps comprising displaying a new soft key label on the user interface display as the static image after completion of the soft key animation routine.

11. The mobile device of claim 7, wherein the processor executable software instructions stored in the memory are configured to cause the processor to further perform steps comprising presenting a series of intermediary images in short succession to create the appearance of a rollover of a soft key lab.

12. A mobile device, comprising:
a user interface display;
a user interface keypad, the user interface keypad including at least one soft key;
a processor coupled to the user interface keypad and the user interface display; and
a memory coupled to the processor; said memory having stored therein processor executable software instructions configured to cause the processor to perform steps comprising:
displaying a soft key label associated with the at least one soft key;
determining whether the entire user interface display requires a change upon initiation of a new application;
determining whether the initiation of the new application requires the change to the soft key label;
activating a soft key animation routine only if the newly initiated application requires the change to the soft key label but not to the entire interface display.

13. A mobile device, comprising:
means for displaying a soft key label;
means for determining whether a change to the soft key label is required; and
means for activating a soft key animation routine if the newly initiated application requires the change to the soft key label.

14. The mobile device of claim 13, further comprising:
means for monitoring whether a new application has been initiated; and
means for determining whether the change to a soft key label is required is performed only if the new application has been initiated.

15. The mobile device of claim 13 wherein the means for activating the soft key animation routine comprises a means for displaying a series of images stored in memory prior to displaying a static image including a changed soft key label.

16. The mobile device of claim 15, further comprising means for displaying a new soft key label on the user interface display as the static image after completion of the soft key animation routine.

17. The mobile device of claim 13, wherein the means for activating the soft key animation routine comprises means for presenting a series of intermediary images in short succession to create the appearance of a rollover of a soft key 1.

18. A mobile device comprising:
means for displaying a soft key label;
means for determining whether the entire user interface display requires a change upon initiation of a new application;
means for determining whether the initiation of the new application requires a change to the soft key label; and
means for activating a soft key animation routine only if the newly initiated application requires the change to the soft key label but not to the entire interface display.

19. A tangible processor-readable storage medium having stored thereon processor-executable software instructions configured to cause a processor to perform steps comprising:
determining whether a change to a soft key label is required; and
activating a soft key animation routine if the newly initiated application requires the change to the soft key label.

20. The tangible processor-readable storage medium of claim 19 further having stored thereon processor-executable software instructions configured to cause the processor to perform further steps comprising:
monitoring whether a new application has been initiated; and
performing the step of determining whether the change to the soft key label is required is performed only if the new application has been initiated.

21. The tangible processor-readable storage medium of claim 19 further having stored thereon processor-executable software instructions configured to cause the processor to perform further steps comprising displaying a series of images stored in memory prior to displaying a static image including a changed soft key label.

22. The tangible processor-readable storage medium of claim 21 further having stored thereon processor-executable software instructions configured to cause the processor to perform further steps comprising displaying a new soft key label on the user interface display as the static image after completion of the soft key animation routine.

23. The tangible processor-readable storage medium of claim 19 further having stored thereon processor-executable software instructions configured to cause the processor to perform further steps comprising presenting a series of intermediary images in short succession to create an appearance of a rollover of the soft key label.

24. A tangible processor-readable storage medium having stored thereon processor-executable software instructions configured to cause a processor to perform steps comprising:
displaying a soft key label;
determining whether an entire user interface display requires a change upon initiation of a new application;
determining whether the initiation of the new application requires a change to the soft key label;
activating a soft key animation routine only if the newly initiated application requires the change to the soft key label but not to the entire interface display.
